(19) United States
(12) Patent Application Publication
(10) Pub. No.: US 2013/0112353 A1
(43) Pub. Date: May 9, 2013

(54) CORDLESS WINDOW BLIND ASSEMBLY

(71) Applicant: John Sengelaub, Wantagh, NY (US)

(72) Inventor: John Sengelaub, Wantagh, NY (US)

(73) Assignee: Welcome Industrial, Deer Park, NY (US)

(21) Appl. No.: 13/289,395

(22) Filed: Nov. 4, 2011

(51) Int. Cl. A47H 23/04; E06B 9/38; A47H 23/00

(52) U.S. Cl. 160/84.02; 160/340; 160/192

(57) ABSTRACT

A cordless window blind includes a headrail; a first bottom rail suspended from the headrail by a first cord and a second cord; a window covering disposed between the headrail and the first bottom rail and movable between a raised configuration and a lowered configuration; a drive actuator including a spring motor including a drive wheel, a driven wheel, and an elongated spring belt having a first end secured to the drive wheel and a second end secured to the driven wheel, wherein the spring belt includes a length with a tapered width. Further included are first and second spools having a conical circumferential surface around which the first and second cords are respectively wound when the window covering is in the raised configuration. Also included is a hinged valence arm.

### BACKGROUND

1. Field of the Invention

The present disclosure generally relates to window treatments, and more particularly to Roman style window shades equipped with liners.

2. Background of the Art

Individuals occupying a building space including unadorned windows may from time to time wish to have some means of improving the appearance of the windows, blocking sunlight from entering the building space through the window, or preventing others from observing them by peering through the window. Window treatments are well known for covering windows and adjacent areas. Window treatments are available in various devices such as, for example, curtains, drapes, blinds, and shades. These devices can be used in many applications, including use for provision of visual barriers, physical separation, privacy, protection from strong sunlight, and decoration.

Some window coverings incorporate lift cords to raise and lower a shade panel. With the use of such lift cords can come certain design problems. For example, to the extent such lift cords are visible, either to observers occupying the building space within which the window covering is installed, or to observers viewing the window covering through the adjacent architectural feature, the relative attractiveness of the window covering may suffer. In addition, to the extent the design of such window covering is such as to permit an individual (such as an unsupervised child) to gain access to or grasp such a lift cord, and/or to pull at the lift cord sufficiently to form a loop large enough for him or her to pass his head through the loop, safety concerns will arise. This disclosure describes an improvement over these prior art technologies.

Spring motors are known to be provided to assist the elevating and lowering of a variable load such as that provided by a Venetian blind type window covering. Spring motors conventionally comprise a flat ribbon of spring metal which is pre-stressed and coiled so as to have a natural or relaxed state in which the spring forms a tightly wound coil disposed on or in a spring storage or take up drum. The extended free end of the coil is attached to the hub of an output or spring drive drum onto which the spring is backwound by rotating the output drum in a direction to back or reverse wind the spring thereon. When the load to which the output drum is connected is released, the curling property of the spring causes it to rewind onto or into the storage drum toward its natural or relaxed state. Such spring motors as descried above can be of constant or variable force, depending upon the intended use of the motor. The characteristics of a variable force spring motor can be obtained in varying ways, but varying the radius of curvature of the spring member along the length thereof is conventionally the preferred method.

In connection with the use of such a spring motor and a venetian blind, as an example, a control drum or spool is mounted co-axially with the output drum for rotation therewith, and the flexible member or cord is wound onto the spool in a direction which provides for the unwinding of the cord to rotate the spring output drum in the direction for winding the spring member thereon from the spring storage drum. When the force necessary for such unwinding is relaxed, the spring member returns to its naturally coiled position whereby the spring output drum is rotated by the spring member in a direction to rewind the cord or belt onto the spool. In those blinds with locking mechanism, such rewinding of the cord onto the control drum is inhibited.

When raising or lowering a load such as the bottom rail and slats of a Venetian blind accumulating on the bottom rail, a pair of cords may be wound on the spool in opposite directions with the free ends of the cords attached at the opposite ends of the bottom rail. When the bottom rail is lowered, the two cords unwind from the spool thus driving the spring output drum to wind the spring member thereon. Upward displacement of the bottom rail from a lowered position results in the spring member rewinding on the spring storage drum to rotate the spring output drum and thus the control drum in the direction to rewind the two cords. In elevating the lowering a suspended load of the foregoing example type, which is too heavy to provide desire displacement characteristics in connection with the upward and downward movement of the bottom rail, and using a single spring motor, many times it is necessary to provide a larger spring motor or operate two or more spring motors in tandem.

When it is desired, the spring motor may be designed to allow the balancing of the gravitational pull on the bottom rail and accumulated slats and the resisting force of the spring motor so that the weight, even though increasing, as additional slats are accumulated on the bottom rail as it is raised, the bottom rail may be released and stay at a predetermined height. However, this is difficult under many conditions.

Various types of cordless blind arrangements are known. For example, U.S. Pat. No. 7,984,745 to Wen, which is incorporated by reference herein, discloses a cordless window blind structure which includes a movable seat having a pulley block and a cord-winding assembly disposed within a head rail of the cordless blind. The pulley block is connected to a lift cord wound through a first positioning element, so as to control the opening and closing of a blind body. And the cord-winding assembly has a cord winder attached to one end of a retrieving cord and a torsion spring. The other end of the retrieving cord is fastened either on the head rail, the movable seat, a second positioning element, or an end cap. The structure of the second positioning element is resembled to the first positioning element. By taking one end of the retrieving cord as a pivot, the movable seat moves laterally therealong the head rail by a restoring force generated through the torsion spring.

U.S. Pat. No. 7,228,797 to Hillman et al., which is incorporated by reference herein, discloses a cordless blind which includes a headrail, a bottom rail suspended from the headrail by a first cord and a second cord, a wall covering disposed between the headrail and the bottom rail, and a drive actuator. The drive actuator includes a spring motor, a spool coupled to the spring motor, a first tensioning mechanism, and a second tensioning mechanism. The first and second tensioning mechanisms are configured to impact a resistant force on movement of the first and second cords. The drive actuator may include a spool, a spring motor, a biasing element configured to provide a force biased against movement of the bottom rail, and a bias relief mechanism that is configured to provide for selective application and relief of the biasing force by the biasing element. The drive actuator may include a constant biasing element, a generally rigid strap, a mandrel, a biasing member, and a traction wheel including a plurality of cogs extending from the circumference of the traction wheel such that movement of the strap rotates the traction wheel.

U.S. Pat. No. 7,150,304 to Hsu, which is incorporated by reference herein, discloses cordless blind including an upper beam, a body, and a plurality of magnet components. Generally, the body is attached to an underside of the upper beam. The body may include a top and foldable slats. One slat can be the bottommost slat. Generally, the plurality of magnet components are equidistantly distributed from the bottommost slat upward to the top of the body and alignable when the body is in a folded position. The cordless blind can have no pull cords or lift cords.

U.S. Pat. No. 6,932,140 to Ni, which is incorporated by reference herein, discloses a cordless Venetian blind structure that includes a lower beam having a pair of clamps securely sealed at both ends thereof for a left and a right retaining cords to be held thereby before pivotally led through the bottom of the lower beam to be tied up to a windowsill for location thereon. A retaining unit and a control unit are mounted to the middle section of the lower beam respectively with the control unit limited by the retaining unit in pushing operation. A control cord pivotally led through the retaining unit and the control unit respectively at the middle section is attached to the clamps by both ends thereof. In operation, the control unit is pushed inwards to draw in the control cord by both ends and compress spring elements disposed at the clamps therein so as to release the retaining cords from the clamps for adjusting the Venetian blind up or down into a proper position. When the pushing force applied is removed, the clamps are bounced back, clamping tight the retaining cords thereof so as to relocate the Venetian blind at the proper position under the best using condition thereof. Moreover, a pair of coupling bodies can also be attached at both ends of the lower beam thereof with the same effect thereof.

The above identified patents are herein incorporated by reference.

However, a problem with conventional cordless blinds and shades is improper lowering and raising, which causes an uneven bottom rail. The tensioning device applies too much pressure so that after the shade is lowered it retracts upward thereby requiring an additional manual adjustment. Also the valence arm on conventional designs is typically fixed, thereby making packaging more difficult for the assembled shade or blind. The burden of assembling the blind or shade is undesirably placed on the consumer.

Accordingly, it would be advantageous to provide a window covering in which lifting cords and cord mechanisms are eliminated and which avoid the problems mentioned above.

### SUMMARY

A cordless window blind assembly is provided herein which comprises: a headrail; a first bottom rail suspended from the headrail by a first cord and a second cord; a window covering disposed between the headrail and the first bottom rail and movable between a raised configuration and a lowered configuration; a drive actuator including a spring motor including a drive wheel, a driven wheel, and an elongated spring belt having a first end secured to the drive wheel and a second end secured to the driven wheel, wherein the spring belt includes a length with a tapered width. Further included is a frame in which the drive actuator is mounted; a first spool rotatably mounted in the frame and having a conical circumferential surface, the first cord being wound on the conical circumferential surface of the first spool when the window covering is in the raised configuration; and a second spool mounted in the frame and having a conical circumferential surface, the second cord being wound on the conical circumferential surface of the second spool when the window covering is in the raised configuration.

In an embodiment the cordless window blind further includes a second bottom rail spaced apart from and below the first bottom rail, the second bottom rail includes at least one valence arm having opposite first and second ends, wherein said first end is hingedly connected to the second bottom rail and rotatable between a horizontal first orientation wherein the valence arm is parallel to the second bottom rail and a vertical second orientation wherein the second end is engaged in a latch disposed on the first bottom rail.

### BRIEF DESCRIPTION OF THE DRAWINGS

Various embodiments are described below with reference to the drawings wherein:

FIG. 1 is a front perspective view of the shade assembly of the invention;

FIG. 2 is a rear perspective view of the shade assembly of the invention;

FIG. 3 is a front view of the shade assembly with the decorative front flap removed;

FIG. 4 is a top view of the lift mechanism of the shade assembly;

FIG. 5 is a rear view of the lift mechanism;

FIG. 6 is an elevational view of the bottom of the cordless blind assembly with the hinged valence arms; and,

FIG. 7 is a plan view of the spring member.

### DETAILED DESCRIPTION OF PREFERRED EMBODIMENT(S)

The present disclosure generally relates to window treatments, and more particularly to window coverings which can be raised or lowered. As used herein the term “blind” includes both shade panels and slatted blind structures such as Venetian blinds. It is envisioned that the blind assembly disclosed herein may be operated manually by means of one or more lifting mechanisms, and without a lift cord.

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, left and right, are for illustrative purposes only and can be varied within the scope of the disclosure. For example, the references “upper” and “lower” are relative and used only in the context to the other, and are not necessarily “superior” and “inferior”.

The exemplary embodiments shown in the drawings relate generally to the art of drive actuators with spring motors useful for a variety of applications, including window coverings such as Venetian blinds and window shades, which are both encompassed in the meaning of the term “blind” as used herein.

According to any preferred embodiment, the blind is configured to be “balanced” at any of a variety of times. A “balanced” blind is one that maintains its set position or arrangement when released by the operator after the bottom rail is raised or lowered relative to the head rail (i.e., to uncover/cover the window with the window covering).

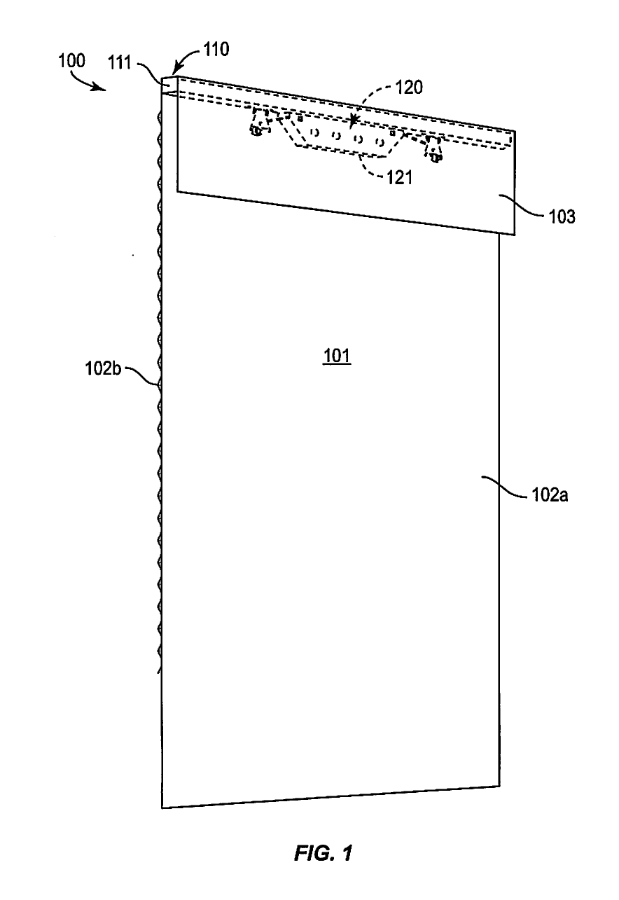

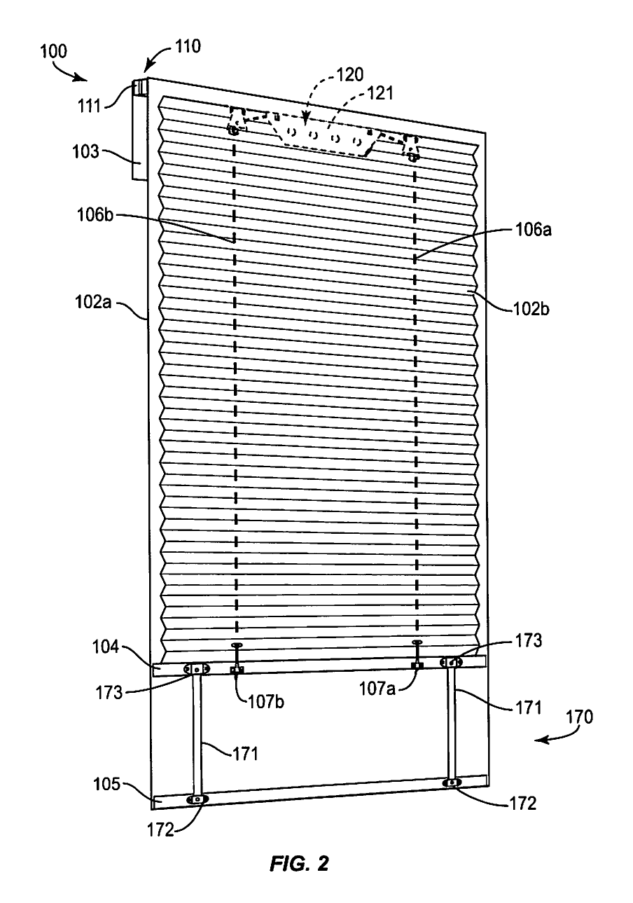

Referring now to FIGS. 1 and 2, the cordless blind assembly 100 of the invention includes a window covering 101, which is manually movable without a lift cord between a raised configuration and a lowered configuration.

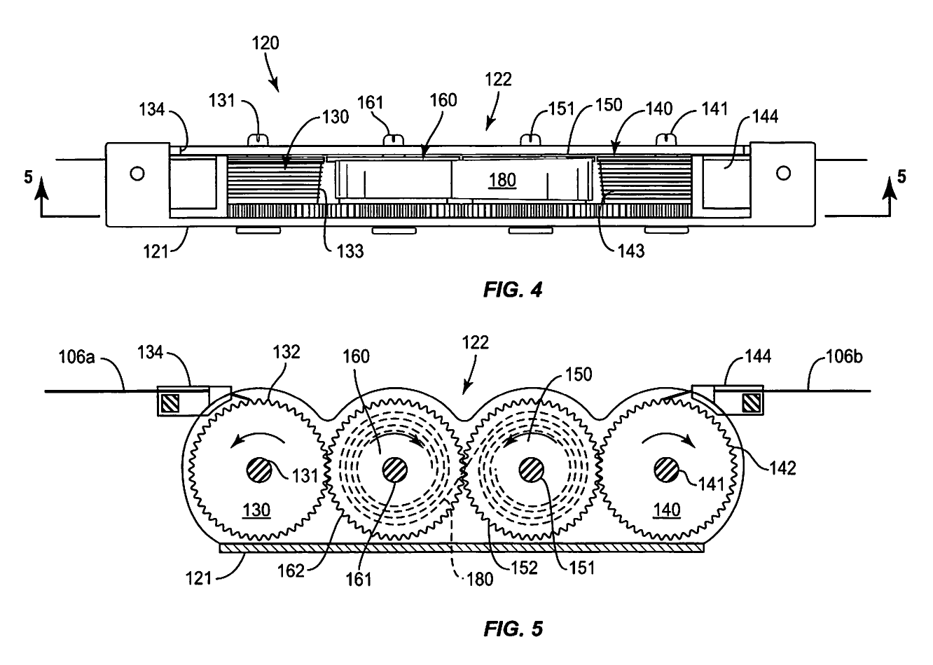

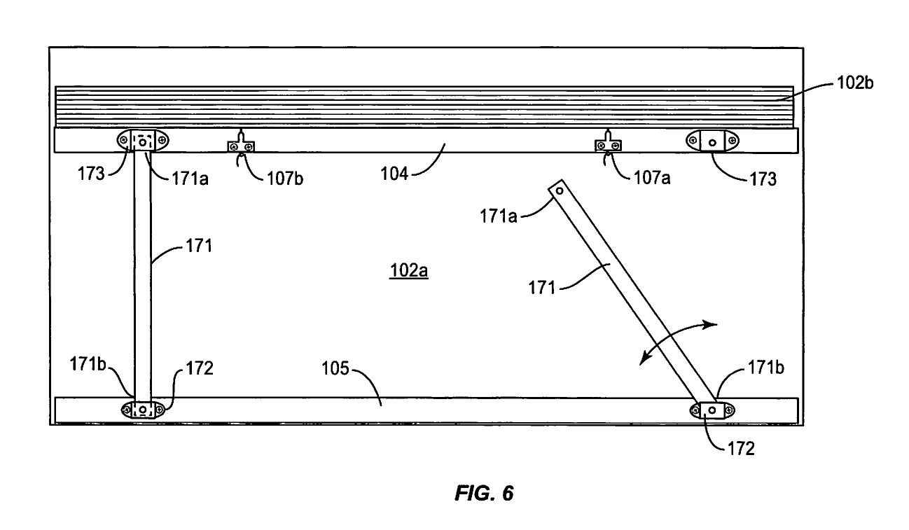

More particularly, in an embodiment the cordless blind assembly comprises a mounting structure 110 including a headrail 111, a first bottom rail 104 suspended from the headrail 111 by a first cord 106a and a second cord 106b. The first cord 106a is attached to the first bottom rail 104 by means of a cord fastener 107a. The second cord 106b, which is spaced apart from and parallel to the first cord 106a, is attached to bottom rail 104 by means of cord fastener 107b. A window covering 101 is disposed between the headrail 111 and the first bottom rail 104 and is movable between a raised configuration and a lowered configuration. A lifting mechanism, i.e., drive actuator 120, includes a frame 121 to which is mounted spring motor 122 (FIGS. 4 and 5) including a drive wheel 150, a driven wheel 160, and an elongated spring belt 180 (FIG. 7) having a first end 181 secured to the drive wheel 150 and a second end 182 secured to the driven wheel 160. The spring belt 180 includes a length with a tapered width. A flap 103 (FIGS. 1 and 2) extends over the front of the drive actuator 120 to provide a decorative cover.

The cordless blind assembly 100 further includes a first spool 130 rotatably mounted in the frame 121 on axle 131 and having a conical circumferential surface 133, the first cord 106a being wound on the conical circumferential surface 133 of the first spool when the window covering 101 is in the raised configuration. A second spool 140 is rotatably mounted in the frame 121 on axle 141 and has a conical circumferential surface 143, the second cord 106b being wound on the conical circumferential surface 143 of the second spool 140 when the window covering is in the raised configuration.

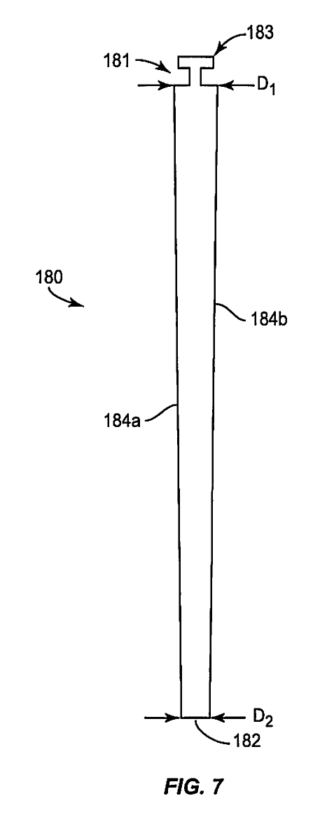

In an embodiment the cordless blind assembly 100 further includes a second bottom rail 105 spaced apart from and below the first bottom rail 104. The second bottom rail 105 includes at least one valence arm 170 having a first end 171a and second end 171b opposite the first end. The first end is rotatably connected to the second bottom rail 105 at a hinge 172 and is rotatable between a horizontal first orientation wherein the valence arm 170 is parallel to the second bottom rail 105 and a vertical second orientation wherein the second end 171b is engaged in a latch 173 disposed on the first bottom rail 104. In an embodiment as shown in FIGS. 2 and 6, the cordless blind assembly 100 includes two valence arms of similar configuration and function.

In an embodiment, the window covering 101 comprises a first shade panel 102a and, adjacent thereto, a second shade panel 102b in parallel arrangement. The second shade panel 102b is of shorter length than the first shade panel and extends between the headrail 111, to which the upper end portion of the second shade panel is connected, and the first bottom rail 104, to which the lower end portion of the second shade panel is connected. The first shade panel 102a extends between the headrail 111, to which the upper end portion of the first shade panel 102a is connected, and the second bottom rail 105 to which the lower end portion of the first shade panel 102a is connected. Second shade panel 102b preferably has a pleated configuration, i.e., a vertical array of horizontal pleats. In an alternative embodiment the window covering 101 can comprise a plurality of horizontal slats in a vertical array such as a Venetian blind structure.

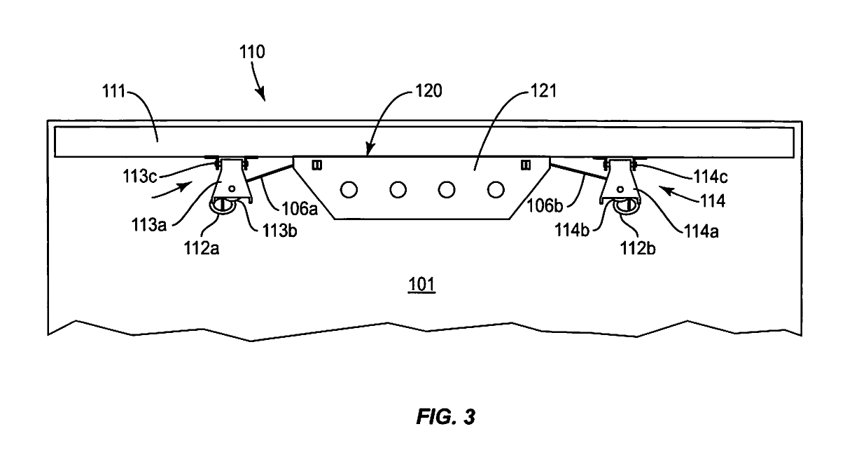

Referring additionally now to FIGS. 3, 4 and 5, first cord 106a is slidably disposed through ring opening 112a at the upper portion of the window covering 101, and passes through an initial cord guide 113, which includes a housing 113a, a pulley wheel 113b rotatably disposed in the housing 113a, and a hinge attachment 113c to headrail 111. The first cord 106a is guided by the pulley wheel 113b into the drive actuator 120. The second cord 106b is slidably disposed through ring opening 112b at the upper portion of the window covering 101, and passes through an initial cord guide 114, which includes a housing 114a, a pulley wheel 114b rotatably disposed in the housing 114a, and a hinge attachment 114c to headrail 111. The second cord 106b is guided by the pulley wheel 114b into the drive actuator 120 from a direction opposite to that of the first cord 106a.

The cord 106a is guided by a supplemental second cord guide 134 (FIGS. 4 and 5) having a channel through which the cord 106a is slidably disposed, and passes on to the circumferential conical surface 133 of spool 130. Cord 106b is guided by a supplemental second guide 144 (FIGS. 4 and 5) having a channel through which the cord 106b is slidably disposed and passes on to the circumferential conical surface 143 of spool 140. Spool 130 is rotatably mounted within frame 121 on axle 131. Spool 140 is rotatably mounted within frame 121 on axle 141.

The spring motor 122 includes a drive wheel 150 and a driven wheel 160. The drive wheel 150 is rotatably mounted in frame 121 on axle 151. The driven wheel 160 is rotatably mounted in frame 121 on axle 161. Axle 131 of the first spool 130, axle 141 of the second spool 140, axle 151 of the drive wheel 150 and axle 161 of the driven wheel are aligned in a parallel orientation and are configured in a linear arrangement in the frame 121. Moreover, first spool 130 includes a toothed circumferential peripheral edge 132, second spool 140 includes a toothed circumferential peripheral edge 142, drive wheel 150 includes a toothed circumferential peripheral edge 152 and driven wheel 160 includes a toothed circumferential peripheral edge 162. In an embodiment the circumferential peripheral edge 132 of the first spool 130 engages with the circumferential peripheral edge 162 of the driven wheel 160 and the circumferential peripheral edge 142 of the second spool engages the circumferential peripheral edge 152 of the drive wheel. However, in another embodiment, wheel 160 can function as the drive wheel and wheel 150 can function as the driven wheel, as explained below.

Referring also now to FIG. 7, the spring motor 122 includes a resilient spring member 180, which is illustrated in plan view in an uncoiled configuration. Spring member 180 includes a substantially flat strip of resilient material such as, preferably, spring steel or other appropriate metal such as bronze or other non-ferrous alloy. Alternatively, spring 180 can be fabricated from a suitable engineering plastic. Spring 180 has a first end 181, an opposite second end 182, and a mounting portion 183 at the first end to facilitate attachment to a corresponding latching fixture on a cylindrical surface of the drive wheel 150. Spring 180 has a wider width D₁ at first end 181 than width D₂ at narrower end 182. Accordingly, the longitudinal edges 184a and 184b are not parallel. Rather, edges 184a and 184b uniformly taper from end 181 to end 182. End 182 is fastened to a circumferential surface of driven wheel 160. As can be seen from FIG. 5, the spring 180 is at least partially coiled around the drive wheel 150 and the driven wheel 160. When the window covering 101 is in the raised position, the spring 180 is coiled mostly around the drive wheel 150, cord 106a is coiled mostly on circumferential surface 133, and cord 106b is coiled mostly around circumferential surface 143. As the window covering 101 is lowered the spools 130 and 140, and wheels 150 and 160, turn in the direction indicated by the arrows, letting out cords 106a and 106b and moving spring 180 into drawn wheel 160.

As shown in FIG. 5, the drive wheel 150 is engaged with spool 140 and the driven wheel 160 is engaged with spool 130. This ordering can be reversed by having wheel 160 be the drive wheel and wheel 150 being the driven wheel according to which end of the spring is attached to the wheels 150 and 160. Typically, the end of the spring 180 having the greater width (i.e., end 181) is fastened to the drive wheel.

The invention described herein maintains the bottom rails 104, 106 in an even, horizontal orientation at any position between the raised and lowered configuration. Moreover, the taper and shape of the spring 180 adjusts the tension on the window covering to achieve a balance of forces which that when manually lowered, the window covering does not spring back upward when released.

The configuration of the hinged valence arms 171, which allows the arms to be folded onto the second bottom rail 105 allows the cordless blind assembly to be packaged as assembled, thereby relieving the consumer of having to assemble the cordless blind assembly 100 before installation.

In an embodiment the window covering 101 can be fabricated from woven bamboo or other suitable material. The various mechanical components of the cordless blind assembly 100 such as the headrail and bottom rails, the spools and wheels, the valence arm, etc., can be fabricated from any suitable material such as wood, metal, or engineering plastic.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A cordless blind assembly comprising:
a headrail;
a first bottom rail suspended from the headrail by a first cord and a second cord;
a window covering disposed between the headrail and the first bottom rail and movable between a raised configuration and a lowered configuration;
a drive actuator having a spring motor including a drive wheel, a driven wheel, and an elongated spring belt, the spring belt having a first end secured to the drive wheel and a second end secured to the driven wheel, wherein the spring belt includes a length with a tapered width.

2. The cordless blind assembly of claim 1 further including:
a frame in which the drive actuator is mounted;
a first spool rotatably mounted in the frame and having a conical circumferential surface, the first cord being wound on the conical circumferential surface of the first spool when the window covering is in the raised configuration;
a second spool mounted in the frame and having a conical circumferential surface, the second cord being wound on the conical circumferential surface of the second spool when the window covering is in the raised configuration.

3. The cordless blind assembly of claim 1 further including a second bottom rail spaced apart from and below the first bottom rail, the second bottom rail including at least one valence arm having opposite first and second ends, wherein said first end is hingedly connected to the second bottom rail and rotatable between a horizontal first orientation wherein the valence arm is parallel to the second bottom rail and a vertical second orientation wherein the second end is engaged in a latch disposed on the first bottom rail.

4. The cordless blind assembly of claim 3 wherein the window covering comprises a first shade panel and a second shade panel in substantially parallel arrangement, said second shade panel being of shorter length than the first shade panel and extending between and connected to the headrail and the first bottom rail, and the first shade panel extending between and connected to the headrail and the second bottom rail.

5. A cordless blind assembly comprising:
a) shade panel assembly which is movable between a raised configuration and a lowered configuration;
b) a head rail, the shade panel assembly having an upper end connected to the head rail;
c) a drive actuator housed in a frame attached to the head rail;
d) first and second cords operatively associated with the shade panel assembly and connected to the drive motor;
wherein the drive actuator includes
a first spool rotatably mounted in the frame, the first cord being wound on the first spool when the shade panel is in the raised configuration,
a second spool mounted in the frame, the second cord being wound on the second spool when the shade is in the raised configuration,
a drive wheel rotatably mounted to the frame,
a driven wheel rotatably mounted to the frame,
a spring belt having a first end secured to the drive wheel and a second end secured to the driven wheel, wherein the spring belt has a tapered length.

6. The cordless blind assembly of claim 5, wherein said first spool has a conical circumferential surface upon which the first cord is wound.

7. The cordless blind assembly of claim 6, wherein the second spool has a conical circumferential surface on which the second cord is wound.

8. The cordless blind assembly of claim 5 wherein the spring belt is fabricated from a resilient metal.

9. The cordless blind assembly of claim 5 wherein the spring belt has a first end which is attached to the drive wheel and a second end which is attached to the driven wheel, and said spring belt has a greater width at the first end than at the second end.

10. The cordless blind assembly of claim 5 wherein the shade assembly comprises a first shade panel and a second shade panel in parallel arrangement, said second shade panel being of shorter length than the first shade panel.

11. The cordless blind assembly of claim 10 wherein the second shade panel has a pleated structure.

12. The cordless blind assembly of claim 10 comprising a first bottom bar horizontally disposed at a lower end of the first shade panel.

13. The cordless blind assembly of claim 12 comprising a second bottom bar disposed at a lower end of the second shade panel and spaced apart from the first bottom bar.

14. The cordless blind assembly of claim 13 wherein the first and second cords are attached to the second bottom bar.

15. The cordless blind assembly of claim 13 further comprising at least one valence arm having opposite first and second ends, wherein said first end is hingedly connected to the first bottom bar and rotatable between a horizontal first orientation wherein the valence arm is parallel to the first bottom bar and a vertical second orientation wherein the second end is engaged in a latch disposed on the second bottom bar.

16. The cordless blind assembly of claim 5 wherein the first spool, the second spool, the drive wheel and the driven wheel each have a respective circumferential toothed periphery.

17. The cordless blind assembly of claim 16 wherein the first spool is rotatably engaged with the driven wheel, the driven wheel is rotatably engaged with the drive wheel, and the drive wheel is rotatably engaged with the second spool.

18. The cordless blind assembly of claim 5 wherein the first spool, the second spool, the drive wheel and the driven wheel each have a respective axis of rotation, said axes being configured in parallel arrangement.

19. The cordless blind assembly of claim 5 wherein the first spool, the second spool, the drive wheel and the driven wheel are configured in a linear arrangement.

20. The cordless blind assembly of claim 5 further including first and second roller cord guides attached to the head rail.
